(19) United States
(12) Patent Application Publication
(10) Pub. No.: US 2025/0178279 A1
(43) Pub. Date: Jun. 5, 2025

(54) METHOD AND SYSTEM FOR DELIVERING BUILDING MATERIAL TO A PRINTING HEAD

(71) Applicant: Stratasys Ltd., Rehovot (IL)

(72) Inventors: Tal SAIDI, Neve Mivtach (IL); Omer SINWANI, Petach-Tikva (IL); Gai OTTOLENGHI, Rehovot (IL); Dan MORDECHAY, Mazkeret Batya (IL); Shai SULTAN, Moshav Ganei Tal (IL)

(73) Assignee: Stratasys Ltd., Rehovot (IL)

(21) Appl. No.: 18/724,676

(22) PCT Filed: Dec. 29, 2022
(86) PCT No.: PCT/IL2022/051413

§ 371 Date: Jun. 27, 2024

Related U.S. Application Data
(60) Provisional application No. 63/294,961, filed on Dec. 30, 2021.

(51) Int. Cl. B29C 64/336; B29C 64/112; B29C 64/209; B29C 64/214; B29C 64/255; B29C 64/35; B29C 64/393; B33Y 30/00; B33Y 40/00; B33Y 50/02

(52) U.S. Cl. CPC B29C 64/336; B29C 64/112; B29C 64/209; B29C 64/214; B29C 64/255; B29C 64/35; B29C 64/393; B33Y 30/00; B33Y 40/00; B33Y 50/02

(57) ABSTRACT

A system for delivering liquid material to a nozzle array of a printing system comprises a cartridge and a vented sub-tank. The cartridge has a cartridge outlet and contains the liquid material. The sub-tank has a sub-tank inlet configured to receive the cartridge outlet to allow the liquid material to flow through the cartridge outlet by gravity, two inlet ports within the sub-tank inlet at different heights relative to a liquid level in the sub-tank, and a sub-tank outlet. The sub-tank outlet is sealingly connectable to the nozzle array by a pipe and has an outlet port below the inlet ports.

### RELATED APPLICATION

This application claims the benefit of priority of U.S. Provisional Patent Application No. 63/294,961 filed on Dec. 30, 2021, the contents of which are incorporated herein by reference in their entirety.

### FIELD AND BACKGROUND OF THE INVENTION

The present invention, in some embodiments thereof, relates to additive manufacturing and, more particularly, but not exclusively, to a method and system for delivering building material to a printing head.

Additive manufacturing (AM) is generally a process in which a three-dimensional (3D) object is manufactured utilizing a computer model of the objects. Such a process is used in various fields, such as design related fields for purposes of visualization, demonstration and mechanical prototyping, as well as for rapid manufacturing (RM). The basic operation of any AM system consists of slicing a three-dimensional computer model into thin cross sections, translating the result into two-dimensional position data and feeding the data to control equipment which manufactures a three-dimensional structure in a layerwise manner.

One type of AM is three-dimensional inkjet printing. In this process, a building material is dispensed from a dispensing head having a set of nozzles to deposit layers on a supporting structure. Depending on the building material, the layers may then be cured or solidified using a suitable device.

Various three-dimensional inkjet printing techniques exist and are disclosed in, e.g., U.S. Pat. Nos. 6,259,962, 6,569,373, 6,658,314, 6,850,334, 7,183,335, 7,209,797, 7,225,045, 7,300,619, 7,479,510, 7,500,846, 7,962,237, and International Publication No. WO2020/194318, the contents of which are hereby incorporated by reference.

### SUMMARY OF THE INVENTION

According to an aspect of some embodiments of the present invention there is provided a system for delivering liquid material to a nozzle array of a printing system. The system comprises a cartridge and a vented sub-tank. The cartridge has a cartridge outlet and contains the liquid material. The sub-tank has a sub-tank inlet configured to receive the cartridge outlet to allow the liquid material to flow through the cartridge outlet by gravity, two inlet ports within the sub-tank inlet at different heights relative to a liquid level in the sub-tank, and a sub-tank outlet. The sub-tank outlet is sealingly connectable to the nozzle array by a pipe and has an outlet port below the inlet ports.

According to some embodiments of the invention the sub-tank comprises a filter having a base below the inlet ports and a top above the inlet ports,

According to some embodiments of the invention the cartridge outlet comprises a valve.

According to some embodiments of the invention the sub-tank inlet comprises a valve actuating member for opening the valve upon engagement between the sub-tank inlet and the cartridge outlet.

According to some embodiments of the invention the sub-tank comprises a neck below the inlet ports. According to some embodiments of the invention the sub-tank comprises an additional neck above the inlet ports.

According to some embodiments of the invention the system comprises a manifold wherein the sub-tank outlet is sealingly connectable to the nozzle array via the manifold.

According to an aspect of some embodiments of the present invention there is provided a system for three-dimensional printing. The system comprises: a plurality of liquid material delivery systems, each comprising the delivery system as delineated above and optionally and preferably as further detailed below, wherein the delivery systems share the manifold, and wherein a sub-tank outlet of each delivery system is connected to a separate manifold inlet. The three-dimensional printing system also comprise a plurality of nozzle arrays each connected to a separate manifold outlet and being configured for dispensing the liquid material received via the manifold, and a computerized controller having a circuit configured for operating the nozzle arrays to sequentially dispense a plurality of layers in a configured pattern corresponding to a shape of a three-dimensional object.

According to some embodiments of the invention the manifold is elevated relative to the sub-tank outlet.

According to some embodiments of the invention the manifold comprises a plurality of pressure sensing ports, each being in fluid communication with a separate sub-tank outlet, and the system comprises a plurality of pressure sensors for sensing pressures at the pressure sensing ports.

According to some embodiments of the invention the computerized controller is configured for receiving signals from the sensors, and for calculating an amount of liquid material at each sub-tank, based on a signal received from a respective pressure sensor.

According to some embodiments of the invention the computerized controller is configured for receiving signals from the sensors, and for calculating a flow rate of liquid material through each nozzle array, based on a signal received from a respective pressure sensor.

According to some embodiments of the invention the computerized controller is configured to identify when the cartridge is empty, and to automatically re-calibrate sensor data corresponding to signals received from a respective pressure sensor, responsively to the identification.

According to some embodiments of the invention the computerized controller is configured to identify when the cartridge is empty, and to automatically re-calibrate voltage to be applied to a respective nozzle array, responsively to the identification.

According to some embodiments of the invention each of the plurality of nozzle arrays is connected to a respective manifold outlet by a pipe, wherein the controller is configured to analyze signals received from a respective sensor to identify presence of an air pocket in the pipe.

According to some embodiments of the invention the system comprises a service station controllable by the computerized controller and being configured for engaging the nozzle arrays and applying suction thereto responsively to a control signal from the computerized controller.

According to some embodiments of the invention the controller is configured to operate the service station to execute a priming protocol at a respective nozzle array, responsively to the identification of the presence of the air pocket.

According to some embodiments of the invention the system comprises a service station controllable by the computerized controller and being configured for engaging the nozzle arrays and applying suction thereto responsively to a control signal from the computerized controller.

According to an aspect of some embodiments of the present invention there is provided a system of three-dimensional printing. The system comprises: a plurality of nozzle arrays each being configured for dispensing liquid material; a computerized controller having a circuit configured for operating the nozzle arrays to sequentially dispense a plurality of layers in a configured pattern corresponding to a shape of a three-dimensional object; and a service station controllable by the computerized controller and being configured for engaging the nozzle arrays and applying suction thereto responsively to a control signal from the computerized controller.

According to some embodiments of the invention the system comprises a tray, wherein the plurality of layers are dispensed on the tray, and wherein the computerized controller is configured for controlling a vertical position of the tray.

According to some embodiments of the invention the computerized controller is configured for controlling a vertical position of the service station to engage the nozzle arrays, and wherein the tray moves along a vertical direction together with the service station.

According to some embodiments of the invention the system comprises a leveling device for leveling the dispensed layers, and wherein during the engagement, a vertical position of the tray is above a vertical position of the leveling device.

According to an aspect of some embodiments of the present invention there is provided a method of priming. The method comprises: providing a system for three-dimensional printing having a liquid material delivery system which comprises the system as delineated above and optionally and preferably as further detailed below, a manifold which is formed with a sensing port and which is sealingly connected to the nozzle array by a first pipe and to the sub-tank by a second pipe, and a pressure sensor for sensing pressures at the pressure sensing port. The method comprises analyzing signals generated by the pressure sensor to identify an air pocket in the first pipe, and removing the air pocket, responsively to the identification, thereby priming the system.

According to some embodiments of the invention the air pocket is removed by applying suction to the nozzle array.

According to some embodiments of the invention the method comprises positioning the nozzle array at a position above the manifold, prior to the application of suction.

According to some embodiments of the invention the air pocket is the removed by squeezing the first pipe.

According to an aspect of some embodiments of the present invention there is provided a printing head for three-dimensional printing. The printing head comprises: a chamber, vertically partitioned by a partition having an inlet port and an outlet port; an array of nozzles in fluid communication with the chamber; and a pressure sensor constituted to measure pressure below the partition.

According to some embodiments of the invention the partition of the printing head has a first surface engaging a first horizontal plane and a second surface engaging a second horizontal plane, wherein the inlet port is at a lowest of the surfaces and the outlet port is at a highest of the surfaces. According to some embodiments of the invention a height difference between the surfaces is from about 5 mm to about 10 mm.

According to some embodiments of the invention the inlet and outlet ports are of approximately the same diameter.

According to some embodiments of the invention a diameter of each of the inlet and outlet ports is less than 1 mm.

According to an aspect of some embodiments of the present invention there is provided a system for three-dimensional printing. The system comprises the printing head with vertically partitioned chamber, and a computerized controller having a circuit configured for operating the printing head to sequentially dispense a plurality of layers in a configured pattern corresponding to a shape of a three-dimensional object, and for estimating a number of active nozzles in the printing head based on a signal received from the pressure sensor during the dispensing.

According to some embodiments of the invention the controller is configured to determine an amount of a pressure drop below the partition based on the signal, and to estimate the number of active nozzles based on the determined amount of pressure drop.

According to some embodiments of the invention the controller is configured to control a delivery of liquid material to the chamber so as to fill at least a volume of the chamber below the partition with the liquid material, and to execute the estimation immediately after the delivery.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D are schematic illustrations of an additive manufacturing system according to some embodiments of the invention;

FIGS. 2A-2C are schematic illustrations of printing heads according to some embodiments of the present invention;

FIGS. 3A and 3B are schematic illustrations demonstrating coordinate transformations according to some embodiments of the present invention;

FIGS. 4A-E are schematic illustrations of a system for delivering liquid material to a nozzle array of a printing system, according to some embodiments of the present invention;

FIGS. 5A-C are schematic illustrations of an exemplary three-dimensional printing system which can employ the system shown in FIGS. 4A-E, according to some embodiments of the present invention;

FIG. 6 shows results of experiments performed by the inventors in which a pressure and an amount of liquid material that was sucked through a sub-tank outlet were monitored;

FIGS. 7A-F are schematic illustrations describing a priming protocol, according to some embodiments of the present invention;

FIGS. 8A-C are schematic illustrations describing a head replacement protocol, according to some embodiments of the present invention;

FIGS. 9A-C are schematic illustrations describing a printing head having a vertically partitioned chamber, according to some embodiments of the present invention; and

FIG. 10 is a graph of the pressure measured by a sensor in mmH₂O as a function of the time, obtained in experiments performed according to some embodiments of the present invention.

### DESCRIPTION OF SPECIFIC EMBODIMENTS OF THE INVENTION

The present invention, in some embodiments thereof, relates to additive manufacturing and, more particularly, but not exclusively, to a method and system for delivering building material to a printing head.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The method and system of the present embodiments manufacture three-dimensional objects based on computer object data in a layerwise manner by forming a plurality of layers in a configured pattern corresponding to the shape of the objects. The formation of the layers is optionally and preferably by printing, more preferably by inkjet printing. The computer object data can be in any known format, including, without limitation, a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY), 3D Manufacturing Format (3MF), Object file format (OBJ) or any other format suitable for Computer-Aided Design (CAD).

The term “object” as used herein refers to a whole three-dimensional object or a part thereof.

Each layer can be formed by an AM apparatus which scans a two-dimensional surface and patterns it. While scanning, the apparatus visits a plurality of target locations on the two-dimensional layer or surface, and decides, for each target location or a group of target locations, whether or not the target location or group of target locations is to be occupied by building material formulation, and which type of building material formulation is to be delivered thereto. The decision is made according to a computer image of the surface.

In preferred embodiments of the present invention the AM comprises three-dimensional printing, more preferably three-dimensional inkjet printing. In these embodiments a building material is dispensed from a printing head having one or more arrays of nozzles to deposit building material in layers on a supporting structure. The AM apparatus thus dispenses building material in target locations which are to be occupied and leaves other target locations void. The apparatus typically includes a plurality of arrays of nozzles, each of which can be configured to dispense a different building material. This is typically achieved by providing the printing head with a plurality of fluid channels separated from each other, wherein each channel receives a different building material through a separate inlet and conveys it to a different array of nozzles.

Thus, different target locations can be occupied by different building material formulations. The types of building material formulations can be categorized into two major categories: modeling material formulation and support material formulation. The support material formulation serves as a supporting matrix or construction for supporting the object or object parts during the fabrication process and/or other purposes, e.g., providing hollow or porous objects. Support constructions may additionally include modeling material formulation elements, e.g. for further support strength.

The modeling material formulation is generally a composition which is formulated for use in additive manufacturing and which is able to form a three-dimensional object on its own, i.e., without having to be mixed or combined with any other substance.

The final three-dimensional object is made of the modeling material formulation or a combination of modeling material formulations or modeling and support material formulations or modification thereof (e.g., following curing). All these operations are well-known to those skilled in the art of solid freeform fabrication.

In some exemplary embodiments of the invention an object is manufactured by dispensing two or more different modeling material formulations, each material formulation from a different array of nozzles (belonging to the same or different printing heads) of the AM apparatus. In some embodiments, two or more such arrays of nozzles that dispense different modeling material formulations are both located in the same printing head of the AM apparatus. In some embodiments, arrays of nozzles that dispense different modeling material formulations are located in separate printing heads, for example, a first array of nozzles dispensing a first modeling material formulation is located in a first printing head, and a second array of nozzles dispensing a second modeling material formulation is located in a second printing head.

In some embodiments, an array of nozzles that dispense a modeling material formulation and an array of nozzles that dispense a support material formulation are both located in the same printing head. In some embodiments, an array of nozzles that dispense a modeling material formulation and an array of nozzles that dispense a support material formulation are located in separate printing heads.

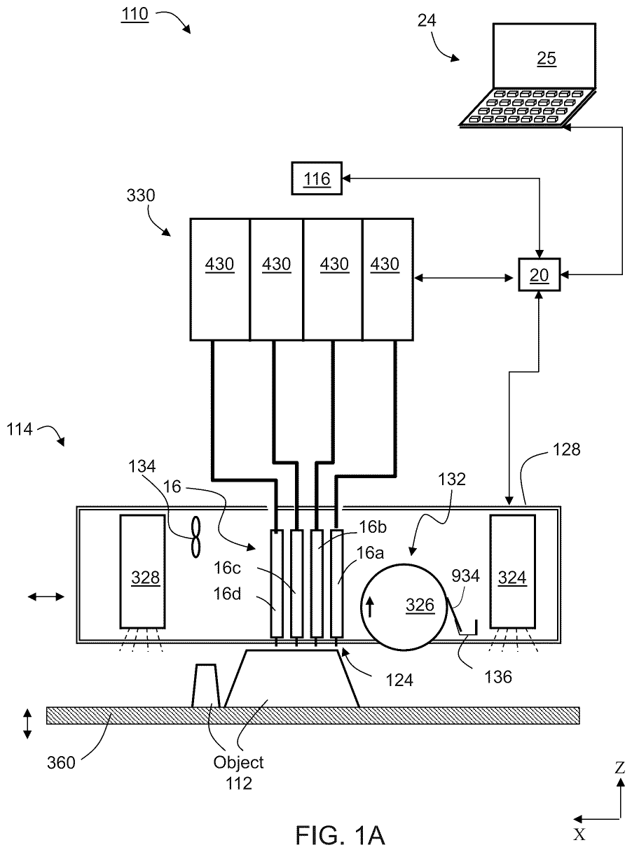

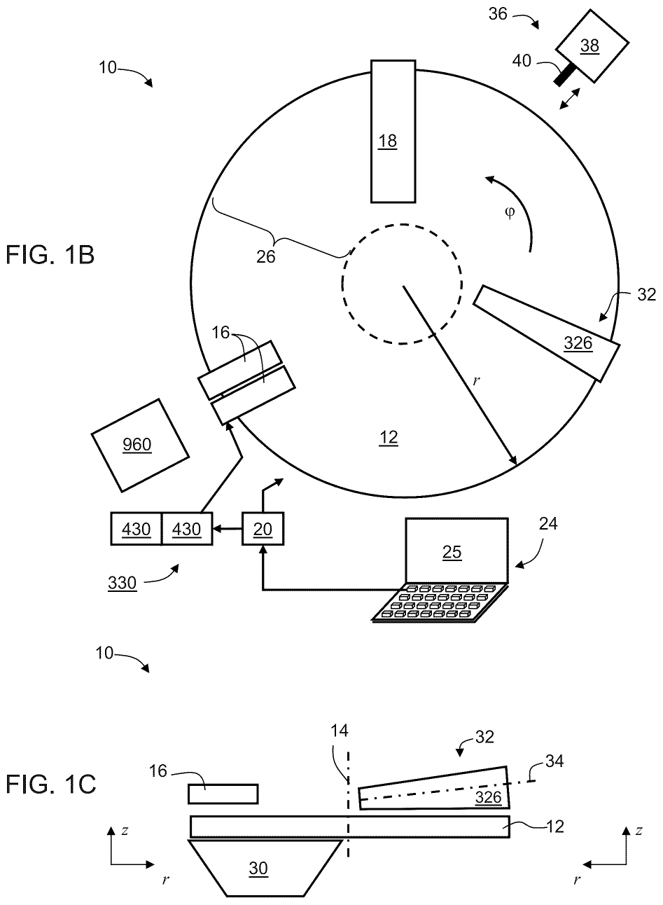

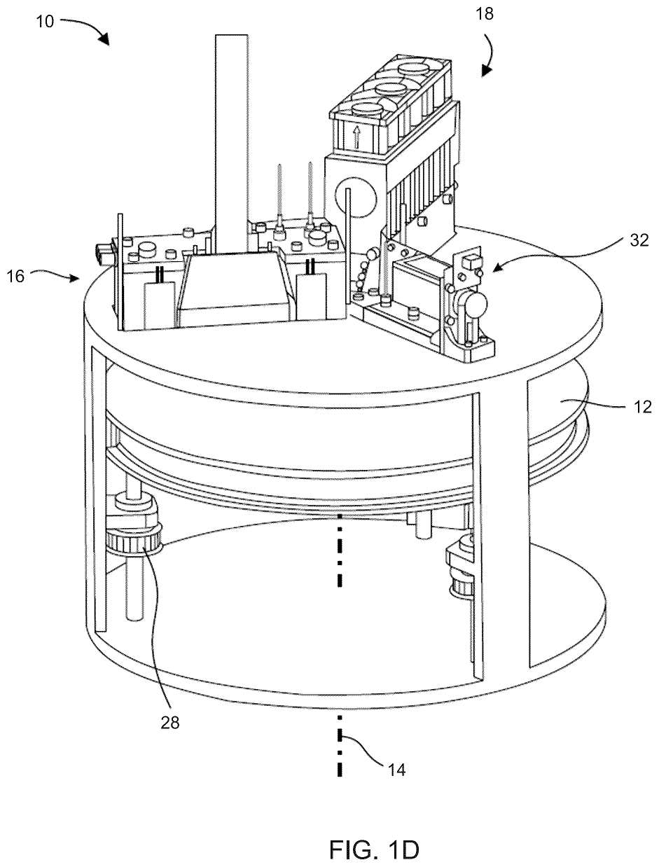

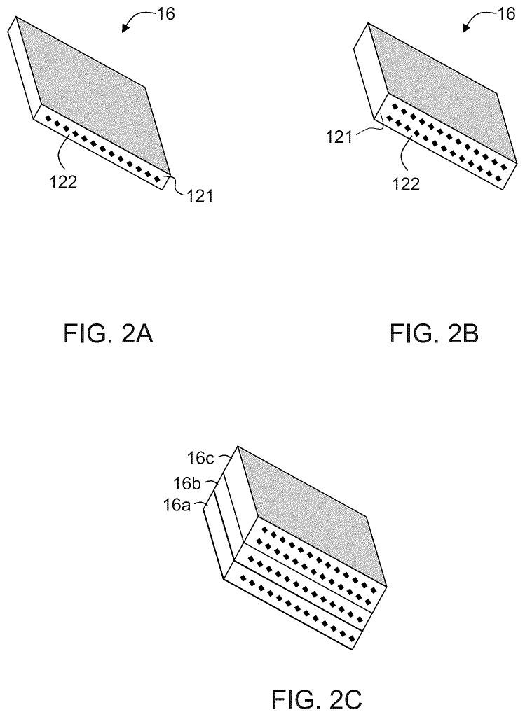

A representative and non-limiting example of a system 110 suitable for AM of an object 112 according to some embodiments of the present invention is illustrated in FIG. 1A. System 110 comprises an additive manufacturing apparatus 114 having a dispensing unit 16 which comprises a plurality of printing heads. Each head preferably comprises one or more arrays of nozzles 122, typically mounted on an orifice plate 121, as illustrated in FIGS. 2A-C described below, through which a liquid building material formulation 124 is dispensed.

Preferably, but not obligatorily, apparatus 114 is a three-dimensional printing apparatus, in which case the printing heads are printing heads, and the building material formulation is dispensed via inkjet technology. This need not necessarily be the case, since, for some applications, it may not be necessary for the additive manufacturing apparatus to employ three-dimensional printing techniques. Representative examples of additive manufacturing apparatus contemplated according to various exemplary embodiments of the present invention include, without limitation, fused deposition modeling apparatus and fused material formulation deposition apparatus.

Each printing head is optionally and preferably fed via one or more building material formulation reservoirs which may optionally include a temperature control unit (e.g., a temperature sensor and/or a heating device), and a material formulation level sensor. To dispense the building material formulation, a voltage signal is applied to the printing heads to selectively deposit droplets of material formulation via the printing head nozzles, for example, as in piezoelectric inkjet printing technology. Another example includes thermal inkjet printing heads. In these types of heads, there are heater elements in thermal contact with the building material formulation, for heating the building material formulation to form gas bubbles therein, upon activation of the heater elements by a voltage signal. The gas bubbles generate pressures in the building material formulation, causing droplets of building material formulation to be ejected through the nozzles. Piezoelectric and thermal printing heads are known to those skilled in the art of solid freeform fabrication. For any types of inkjet printing heads, the dispensing rate of the head depends on the number of nozzles, the type of nozzles and the applied voltage signal rate (frequency).

Optionally, the overall number of dispensing nozzles or nozzle arrays is selected such that half of the dispensing nozzles are designated to dispense support material formulation and half of the dispensing nozzles are designated to dispense modeling material formulation, i.e. the number of nozzles jetting modeling material formulations is the same as the number of nozzles jetting support material formulation. In the representative example of FIG. 1A, four printing heads 16a, 16b, 16c and 16d are illustrated. Each of heads 16a, 16b, 16c and 16d has a nozzle array. In this Example, heads 16a and 16b can be designated for modeling material formulation/s and heads 16c and 16d can be designated for support material formulation. Thus, head 16a can dispense one modeling material formulation, head 16b can dispense another modeling material formulation and heads 16c and 16d can both dispense support material formulation. In an alternative embodiment, heads 16c and 16d, for example, may be combined in a single head having two nozzle arrays for depositing support material formulation. In a further alternative embodiment any one or more of the printing heads may have more than one nozzle arrays for depositing more than one material formulation, e.g. two nozzle arrays for depositing two different modeling material formulations or a modeling material formulation and a support material formulation, each formulation via a different array or number of nozzles.

Yet it is to be understood that it is not intended to limit the scope of the present invention and that the number of modeling material formulation printing heads (modeling heads) and the number of support material formulation printing heads (support heads) may differ. Generally, the number of arrays of nozzles that dispense modeling material formulation, the number of arrays of nozzles that dispense support material formulation, and the number of nozzles in each respective array are selected such as to provide a predetermined ratio, a, between the maximal dispensing rate of the support material formulation and the maximal dispensing rate of modeling material formulation. The value of the predetermined ratio, a, is preferably selected to ensure that in each formed layer, the height of modeling material formulation equals the height of support material formulation. Typical values for a are from about 0.6 to about 1.5.

As used herein throughout the term “about” refers to +10%.

For example, for a=1, the overall dispensing rate of support material formulation is generally the same as the overall dispensing rate of the modeling material formulation when all the arrays of nozzles operate.

Apparatus 114 can comprise, for example, M modeling heads each having m arrays of p nozzles, and S support heads each having s arrays of q nozzles such that M×m×p=S×s×q. Each of the M×m modeling arrays and S×s support arrays can be manufactured as a separate physical unit, which can be assembled and disassembled from the group of arrays. In this embodiment, each such array optionally and preferably comprises a temperature control unit and a material formulation level sensor of its own, and receives an individually controlled voltage for its operation.

Apparatus 114 can further comprise a solidifying device 324 which can include any device configured to emit light, heat or the like that may cause the deposited material formulation to harden. For example, solidifying device 324 can comprise one or more radiation sources, which can be, for example, an ultraviolet or visible or infrared lamp, or other sources of electromagnetic radiation, or electron beam source, depending on the modeling material formulation being used. In some embodiments of the present invention, solidifying device 324 serves for curing or solidifying the modeling material formulation.

In addition to solidifying device 324, apparatus 114 optionally and preferably comprises an additional radiation source 328 for solvent evaporation. Radiation source 328 optionally and preferably generates infrared radiation. In various exemplary embodiments of the invention solidifying device 324 comprises a radiation source generating ultraviolet radiation, and radiation source 328 generates infrared radiation.

In some embodiments of the present invention apparatus 114 comprises cooling system 134 such as one or more fans or the like

The printing head(s) and radiation source are preferably mounted in a frame or block 128 which is preferably operative to reciprocally move over a tray 360, which serves as the working surface. In some embodiments of the present invention the radiation sources are mounted in the block such that they follow in the wake of the printing heads to at least partially cure or solidify the material formulations just dispensed by the printing heads. Tray 360 is positioned horizontally. According to the common conventions an X-Y-Z Cartesian coordinate system is selected such that the X-Y plane is parallel to tray 360. Tray 360 is preferably configured to move vertically (along the Z direction), typically downward. In various exemplary embodiments of the invention, apparatus 114 further comprises one or more leveling devices 32, e.g. a roller 326. Leveling device 326 serves to straighten, level and/or establish a thickness of the newly formed layer prior to the formation of the successive layer thereon. Leveling device 32 preferably comprises a waste collection device 136 for collecting the excess material formulation generated during leveling. Waste collection device 136 may comprise any mechanism that delivers the material formulation to a waste tank or waste cartridge.

In use, the printing heads of unit 16 move in a scanning direction, which is referred to herein as the X direction, and selectively dispense building material formulation in a predetermined configuration in the course of their passage over tray 360. The building material formulation typically comprises one or more types of support material formulation and one or more types of modeling material formulation. The passage of the printing heads of unit 16 is followed by the curing of the modeling material formulation(s) by radiation source 126. In the reverse passage of the heads, back to their starting point for the layer just deposited, an additional dispensing of building material formulation may be carried out, according to predetermined configuration. In the forward and/or reverse passages of the printing heads, the layer thus formed may be straightened by leveling device 32, which preferably follows the path of the printing heads in their forward and/or reverse movement. Once the printing heads return to their starting point along the X direction, they may move to another position along an indexing direction, referred to herein as the Y direction, and continue to build the same layer by reciprocal movement along the X direction. Alternately, the printing heads may move in the Y direction between forward and reverse movements or after more than one forward-reverse movement. The series of scans performed by the printing heads to complete a single layer is referred to herein as a single scan cycle.

Once the layer is completed, tray 360 is lowered in the Z direction to a predetermined Z level, according to the desired thickness of the layer subsequently to be printed. The procedure is repeated to form three-dimensional object 112 in a layerwise manner.

In another embodiment, tray 360 may be displaced in the Z direction between forward and reverse passages of the printing head of unit 16, within the layer. Such Z displacement is carried out in order to cause contact of the leveling device with the surface in one direction and prevent contact in the other direction.

The present embodiments contemplate use of a liquid material formulation supply system 330, which comprises one or more liquid material containers or cartridges 430, and which supplies the liquid material(s) to printing heads. Supply system 330 can be used in an AM system such as system 110, in which case the liquid material in each container is a building material.

A controller 20 controls fabrication apparatus 114 and optionally and preferably also supply system 330. Controller 20 typically includes an electronic circuit configured to perform the controlling operations. Controller 20 preferably communicates with a computer 24 which transmits digital data pertaining to fabrication instructions based on computer object data, e.g., a CAD configuration represented on a computer readable medium in a form of a Standard Tessellation Language (STL) format or the like. Typically, controller 20 controls the voltage applied to each printing head or each nozzle array and the temperature of the building material formulation in the respective printing head or respective nozzle array.

Once the manufacturing data is loaded to controller 20 it can operate without user intervention. In some embodiments, controller 20 receives additional input from the operator, e.g., using computer 24 or using a user interface 116 communicating with controller 20. User interface 116 can be of any type known in the art, such as, but not limited to, a keyboard, a touch screen and the like. For example, controller 20 can receive, as additional input, one or more building material formulation types and/or attributes, such as, but not limited to, color, characteristic distortion and/or transition temperature, viscosity, electrical property, magnetic property. Other attributes and groups of attributes are also contemplated.

Another representative and non-limiting example of a system 10 suitable for AM of an object according to some embodiments of the present invention is illustrated in FIGS. 1B-D. FIGS. 1B-D illustrate a top view (FIG. 1B), a side view (FIG. 1C) and an isometric view (FIG. 1D) of system 10.

In the present embodiments, system 10 comprises a tray 12 and a plurality of inkjet printing heads 16, each having one or more arrays of nozzles with respective one or more pluralities of separated nozzles. The material used for the three-dimensional printing is supplied to heads 16 by building material supply system 330, with one or more liquid material containers or cartridges 430, as further detailed hereinabove. Tray 12 can have a shape of a disk or it can be annular. Non-round shapes are also contemplated, provided they can be rotated about a vertical axis.

Tray 12 and heads 16 are optionally and preferably mounted such as to allow a relative rotary motion between tray 12 and heads 16. This can be achieved by (i) configuring tray 12 to rotate about a vertical axis 14 relative to heads 16, (ii) configuring heads 16 to rotate about vertical axis 14 relative to tray 12, or (iii) configuring both tray 12 and heads 16 to rotate about vertical axis 14 but at different rotation velocities (e.g., rotation at opposite direction). While some embodiments of system 10 are described below with a particular emphasis to configuration (i) wherein the tray is a rotary tray that is configured to rotate about vertical axis 14 relative to heads 16, it is to be understood that the present application contemplates also configurations (ii) and (iii) for system 10. Any one of the embodiments of system 10 described herein can be adjusted to be applicable to any of configurations (ii) and (iii), and one of ordinary skills in the art, provided with the details described herein, would know how to make such adjustment.

In the following description, a direction parallel to tray 12 and pointing outwardly from axis 14 is referred to as the radial direction r, a direction parallel to tray 12 and perpendicular to the radial direction r is referred to herein as the azimuthal direction φ, and a direction perpendicular to tray 12 is referred to herein is the vertical direction z.

The radial direction r in system 10 enacts the indexing direction y in system 110, and the azimuthal direction φ enacts the scanning direction x in system 110. Therefore, the radial direction is interchangeably referred to herein as the indexing direction, and the azimuthal direction is interchangeably referred to herein as the scanning direction.

The term “radial position,” as used herein, refers to a position on or above tray 12 at a specific distance from axis 14. When the term is used in connection to a printing head, the term refers to a position of the head which is at specific distance from axis 14. When the term is used in connection to a point on tray 12, the term corresponds to any point that belongs to a locus of points that is a circle whose radius is the specific distance from axis 14 and whose center is at axis 14.

The term “azimuthal position,” as used herein, refers to a position on or above tray 12 at a specific azimuthal angle relative to a predetermined reference point. Thus, radial position refers to any point that belongs to a locus of points that is a straight line forming the specific azimuthal angle relative to the reference point.

The term “vertical position,” as used herein, refers to a position over a plane that intersect the vertical axis 14 at a specific point.

Tray 12 serves as a building platform for three-dimensional printing. The working area on which one or objects are printed is typically, but not necessarily, smaller than the total area of tray 12. In some embodiments of the present invention the working area is annular. The working area is shown at 26. In some embodiments of the present invention tray 12 rotates continuously in the same direction throughout the formation of object, and in some embodiments of the present invention tray reverses the direction of rotation at least once (e.g., in an oscillatory manner) during the formation of the object. Tray 12 is optionally and preferably removable. Removing tray 12 can be for maintenance of system 10, or, if desired, for replacing the tray before printing a new object. In some embodiments of the present invention system 10 is provided with one or more different replacement trays (e.g., a kit of replacement trays), wherein two or more trays are designated for different types of objects (e.g., different weights) different operation modes (e.g., different rotation speeds), etc. The replacement of tray 12 can be manual or automatic, as desired. When automatic replacement is employed, system 10 comprises a tray replacement device 36 configured for removing tray 12 from its position below heads 16 and replacing it by a replacement tray (not shown). In the representative illustration of FIG. 1B tray replacement device 36 is illustrated as a drive 38 with a movable arm 40 configured to pull tray 12, but other types of tray replacement devices are also contemplated.

Exemplified embodiments for the printing head 16 are illustrated in FIGS. 2A-2C. These embodiments can be employed for any of the AM systems described above, including, without limitation, system 110 and system 10.

FIGS. 2A-B illustrate a printing head 16 with one (FIG. 2A) and two (FIG. 2B) nozzle arrays 22. The nozzles in the array are preferably aligned linearly, along a straight line. Printing head 16 is fed by a liquid material and dispenses it through the nozzle arrays 22, in response to a voltage signal applied thereto by the controller of the printing system. Head 16 is fed by a liquid material which is a building material formulation.

In embodiments in which a particular printing head has two or more linear nozzle arrays, the nozzle arrays are optionally and preferably can be parallel to each other. When a printing head has two or more arrays of nozzles (e.g., FIG. 2B) all arrays of the head can be fed with the same building material formulation, or at least two arrays of the same head can be fed with different building material formulations.

When a system similar to system 110 is employed, all printing heads 16 are optionally and preferably oriented along the indexing direction with their positions along the scanning direction being offset to one another.

When a system similar to system 10 is employed, all printing heads 16 are optionally and preferably oriented radially (parallel to the radial direction) with their azimuthal positions being offset to one another. Thus, in these embodiments, the nozzle arrays of different printing heads are not parallel to each other but are rather at an angle to each other, which angle being approximately equal to the azimuthal offset between the respective heads. For example, one head can be oriented radially and positioned at azimuthal position φ₁, and another head can be oriented radially and positioned at azimuthal position φ₂. In this example, the azimuthal offset between the two heads is φ₁-φ₂, and the angle between the linear nozzle arrays of the two heads is also φ₁-φ₂.

In some embodiments, two or more printing heads can be assembled to a block of printing heads, in which case the printing heads of the block are typically parallel to each other. A block including several inkjet printing heads 16a, 16b, 16c is illustrated in FIG. 2C.

In some embodiments, system 10 comprises a stabilizing structure 30 positioned below heads 16 such that tray 12 is between stabilizing structure 30 and heads 16. Stabilizing structure 30 may serve for preventing or reducing vibrations of tray 12 that may occur while inkjet printing heads 16 operate. In configurations in which printing heads 16 rotate about axis 14, stabilizing structure 30 preferably also rotates such that stabilizing structure 30 is always directly below heads 16 (with tray 12 between heads 16 and tray 12).

Tray 12 and/or printing heads 16 is optionally and preferably configured to move along the vertical direction z, parallel to vertical axis 14 so as to vary the vertical distance between tray 12 and printing heads 16. In configurations in which the vertical distance is varied by moving tray 12 along the vertical direction, stabilizing structure 30 preferably also moves vertically together with tray 12. In configurations in which the vertical distance is varied by heads 16 along the vertical direction, while maintaining the vertical position of tray 12 fixed, stabilizing structure 30 is also maintained at a fixed vertical position.

The vertical motion can be established by a vertical drive 28. Once a layer is completed, the vertical distance between tray 12 and heads 16 can be increased (e.g., tray 12 is lowered relative to heads 16) by a predetermined vertical step, according to the desired thickness of the layer subsequently to be printed. The procedure is repeated to form a three-dimensional object in a layerwise manner.

The operation of inkjet printing heads 16 and optionally and preferably also of one or more other components of system 10, e.g., the motion of tray 12, are controlled by a controller 20. The controller can have an electronic circuit and a non-volatile memory medium readable by the circuit, wherein the memory medium stores program instructions which, when read by the circuit, cause the circuit to perform control operations as further detailed below.

Controller 20 can also communicate with a host computer 24 which transmits digital data pertaining to fabrication instructions based on computer object data, e.g., in a form of a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY) or any other format suitable for Computer-Aided Design (CAD). The object data formats are typically structured according to a Cartesian system of coordinates. In these cases, computer 24 preferably executes a procedure for transforming the coordinates of each slice in the computer object data from a Cartesian system of coordinates into a polar system of coordinates. Computer 24 optionally and preferably transmits the fabrication instructions in terms of the transformed system of coordinates. Alternatively, computer 24 can transmit the fabrication instructions in terms of the original system of coordinates as provided by the computer object data, in which case the transformation of coordinates is executed by the circuit of controller 20.

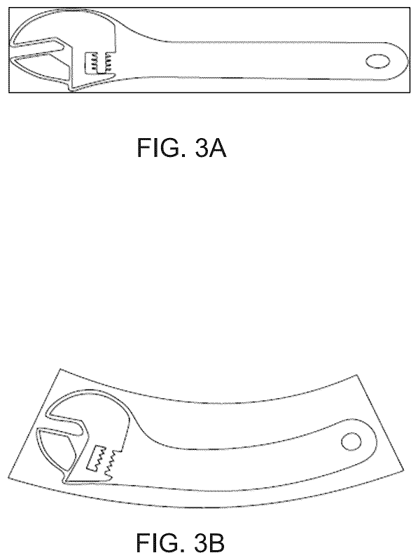

The transformation of coordinates allows three-dimensional printing over a rotating tray. In non-rotary systems with a stationary tray with the printing heads typically reciprocally move above the stationary tray along straight lines. In such systems, the printing resolution is the same at any point over the tray, provided the dispensing rates of the heads are uniform. In system 10, unlike non-rotary systems, not all the nozzles of the head points cover the same distance over tray 12 during at the same time. The transformation of coordinates is optionally and preferably executed so as to ensure equal amounts of excess material formulation at different radial positions. Representative examples of coordinate transformations according to some embodiments of the present invention are provided in FIGS. 3A-B, showing three slices of an object (each slice corresponds to fabrication instructions of a different layer of the objects), where FIG. 3A illustrates a slice in a Cartesian system of coordinates and FIG. 3B illustrates the same slice following an application of a transformation of coordinates procedure to the respective slice.

Typically, controller 20 controls the voltage applied to the respective component of the system 10 based on the fabrication instructions and based on the stored program instructions as described below.

Generally, controller 20 controls printing heads 16 to dispense, during the rotation of tray 12, droplets of building material formulation in layers, such as to print a three-dimensional object on tray 12.

System 10 optionally and preferably comprises one or more radiation sources 18, which can be, for example, an ultraviolet or visible or infrared lamp, or other sources of electromagnetic radiation, or electron beam source, depending on the modeling material formulation being used. Radiation source can include any type of radiation emitting device, including, without limitation, light emitting diode (LED), digital light processing (DLP) system, resistive lamp and the like. Radiation source 18 serves for curing or solidifying the modeling material formulation. In various exemplary embodiments of the invention the operation of radiation source 18 is controlled by controller 20 which may activate and deactivate radiation source 18 and may optionally also control the amount of radiation generated by radiation source 18.

In some embodiments of the invention, system 10 further comprises one or more leveling devices 32 which can be manufactured as a roller 326 or a blade. Leveling device 32 serves to straighten the newly formed layer prior to the formation of the successive layer thereon. In some embodiments, leveling device 32 has the shape of a conical roller positioned such that its symmetry axis 34 is tilted relative to the surface of tray 12 and its surface is parallel to the surface of the tray. This embodiment is illustrated in the side view of system 10 (FIG. 1C).

The conical roller can have the shape of a cone or a conical frustum.

The opening angle of the conical roller is preferably selected such that there is a constant ratio between the radius of the cone at any location along its axis 34 and the distance between that location and axis 14. This embodiment allows roller 32 to efficiently level the layers, since while the roller rotates, any point p on the surface of the roller has a linear velocity which is proportional (e.g., the same) to the linear velocity of the tray at a point vertically beneath point p. In some embodiments, the roller has a shape of a conical frustum having a height h, a radius R₁ at its closest distance from axis 14, and a radius R₂ at its farthest distance from axis 14, wherein the parameters h, R₁ and R₂ satisfy the relation R₁/R₂=(R−h)/h and wherein R is the farthest distance of the roller from axis 14 (for example, R can be the radius of tray 12).

The operation of leveling device 32 is optionally and preferably controlled by controller 20 which may activate and deactivate leveling device 32 and may optionally also control its position along a vertical direction (parallel to axis 14) and/or a radial direction (parallel to tray 12 and pointing toward or away from axis 14.

In some embodiments of the present invention printing heads 16 are configured to reciprocally move relative to tray along the radial direction r. These embodiments are useful when the lengths of the nozzle arrays 22 of heads 16 are shorter than the width along the radial direction of the working area 26 on tray 12. The motion of heads 16 along the radial direction is optionally and preferably controlled by controller 20.

Some embodiments contemplate the fabrication of an object by dispensing different material formulations from different arrays of nozzles (belonging to the same or different printing head). These embodiments provide, inter alia, the ability to select material formulations from a given number of material formulations and define desired combinations of the selected material formulations and their properties. According to the present embodiments, the spatial locations of the deposition of each material formulation with the layer is defined, either to effect occupation of different three-dimensional spatial locations by different material formulations, or to effect occupation of substantially the same three-dimensional location or adjacent three-dimensional locations by two or more different material formulations so as to allow post deposition spatial combination of the material formulations within the layer, thereby to form a composite material formulation at the respective location or locations.

Any post deposition combination or mix of modeling material formulations is contemplated. For example, once a certain material formulation is dispensed it may preserve its original properties. However, when it is dispensed simultaneously with another modeling material formulation or other dispensed material formulations which are dispensed at the same or nearby locations, a composite material formulation having a different property or properties to the dispensed material formulations may be formed.

In some embodiments of the present invention the system dispenses digital material formulation for at least one of the layers.

The phrase “digital material formulations”, as used herein and in the art, describes a combination of two or more material formulations on a pixel level or voxel level such that pixels or voxels of different material formulations are interlaced with one another over a region. Such digital material formulations may exhibit new properties that are affected by the selection of types of material formulations and/or the ratio and relative spatial distribution of two or more material formulations.

As used herein, a “voxel” of a layer refers to a physical three-dimensional elementary volume within the layer that corresponds to a single pixel of a bitmap describing the layer. The size of a voxel is approximately the size of a region that is formed by a building material, once the building material is dispensed at a location corresponding to the respective pixel, leveled, and solidified.

The present embodiments thus enable the deposition of a broad range of material formulation combinations, and the fabrication of an object which may consist of multiple different combinations of material formulations, in different parts of the object, according to the properties desired to characterize each part of the object.

Further details on the principles and operations of an AM system suitable for the present embodiments are found in U.S. Pat. No. 9,031,680, the contents of which are hereby incorporated by reference.

Conventional printing systems, particularly three-dimensional printing systems employ a building material supply system for delivering building material to the nozzle array. Such conventional material supply system typically employs a controllable pump, which pumps building materials from cartridges of building materials to the nozzle array. The present inventors found that building material can be delivered to the nozzle array without employing a pump, wherein the flow of material is established by a combination of gravitational forces and the under-pressure within the printing head on which the nozzle array is mounted. The inventors found that such a pumpless delivery simplifies the printing system, and thus significantly reduces the manufacturing costs of the system.

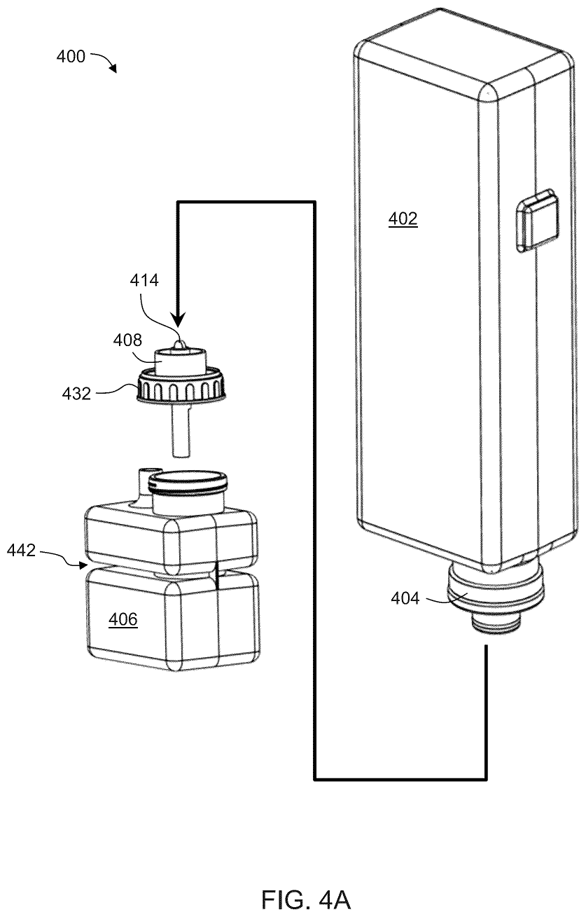

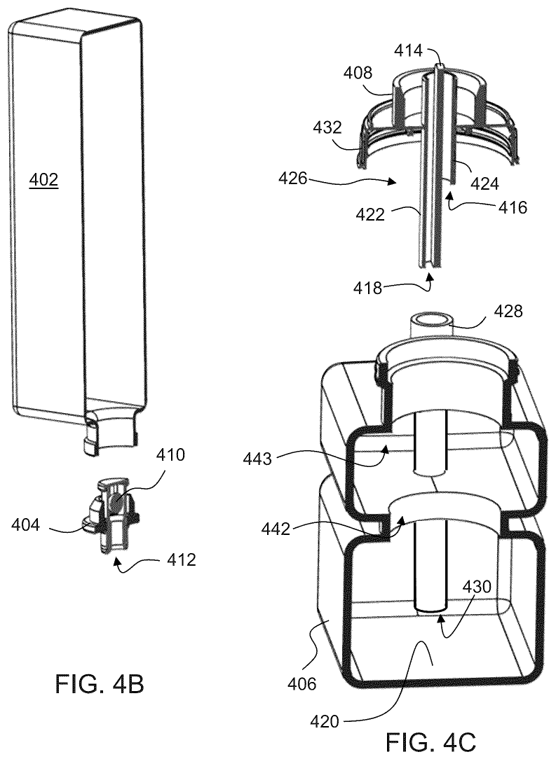

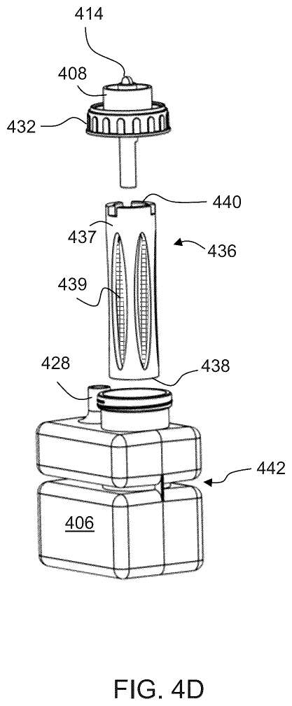

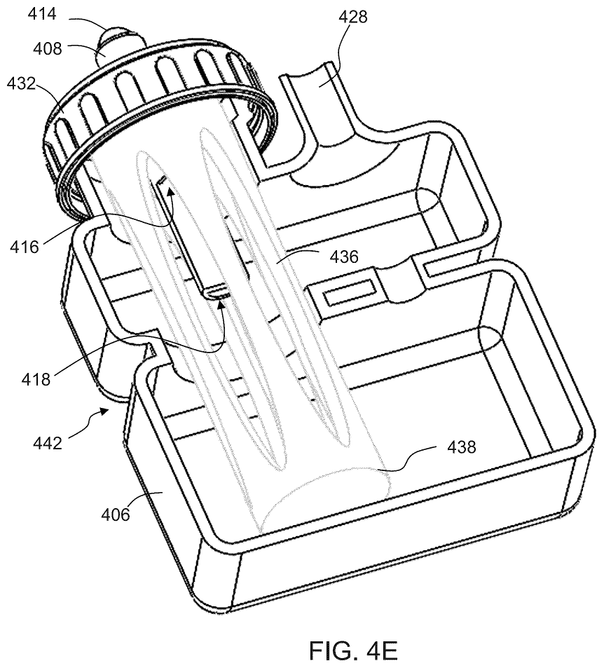

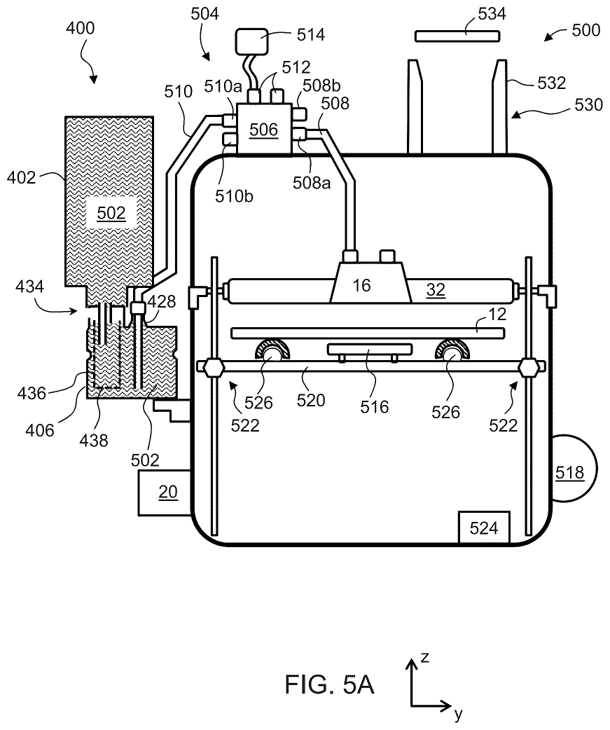

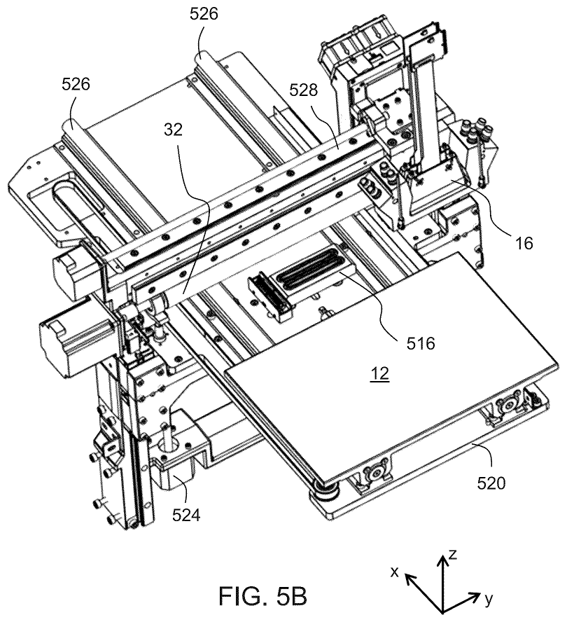

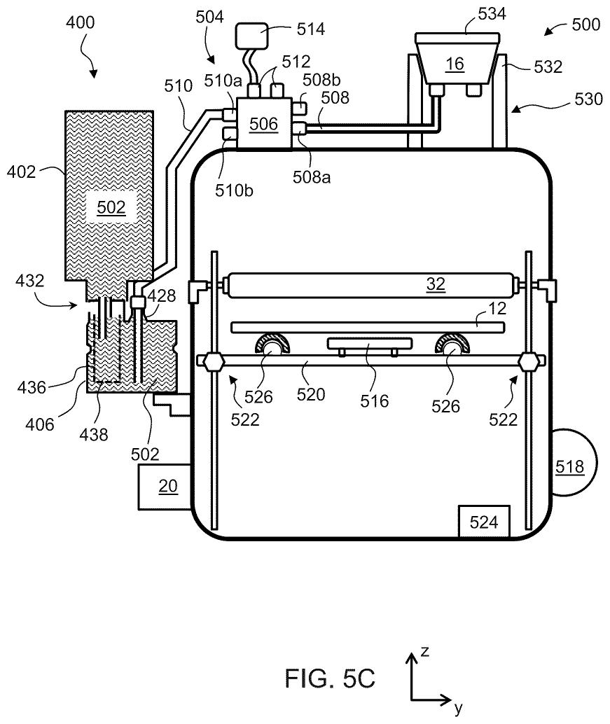

FIGS. 4A-E are schematic illustrations of a system 400 for delivering liquid material to a nozzle array of a printing system, according to some embodiments of the present invention. System 400 can be incorporated in a two-dimensional printing system in which case the liquid material can be a printing ink. System 400 can also be incorporated in a three-dimensional printing system, in which case the liquid material can be a building material. For example, system 400 can be incorporated in system 10 or system 110 described above. An additional exemplary three-dimensional printing system which can employ system 400 is described hereinunder with reference to FIGS. 5A-C.

With reference to FIG. 4A, system 400 comprises a cartridge 402 which contains the liquid material to be delivered (not shown, see FIG. 5A), and which is provided with a cartridge outlet 404. Except for cartridge outlet 404, cartridge 402 is preferably completely sealed, from all sides. An exploded view of a section of cartridge 402 along a vertical axis according to some embodiments of the present invention is schematically illustrated in FIG. 4B. In the illustrated embodiment, cartridge outlet 404 comprises a valve 410, configured for preventing flow of liquid material out of cartridge 402 through cartridge outlet 404, when cartridge outlet 404 is facing downwards. FIG. 4B illustrates valve 410 as a ball valve which is confined to move only within cartridge outlet 404 along the central axis thereof, so that when the ball assumes a lowest position within cartridge outlet 404 the exit port 412 of cartridge outlet 404 is closed, and when the ball is not at the lowest position within cartridge outlet 404 the exit port 412 of cartridge outlet 404 is opened, and liquid may drip out of, or enter, cartridge 402. The ball is heavier than the liquid so that when cartridge outlet 404 is facing downwards, the ball assumes the lowest position and the liquid is prevented from dripping out of cartridge outlet 404. However, it is not necessary for the valve 410 to be a ball valve. The present embodiments contemplate all types of valves at cartridge outlet 404. Further, in some embodiments of the present invention cartridge outlet 404 is provided without a valve.

Referring back to FIG. 4A, system 400 further comprises a sub-tank 406 having a sub-tank inlet 408. As illustrated in the exploded view of FIG. 4A, sub-tank inlet 408 is configured to receive cartridge outlet 404 to allow the liquid material to flow through cartridge outlet 404 by gravity. In embodiment in which cartridge outlet 404 comprises valve 410 (FIG. 4B), sub-tank inlet 408 comprises a valve actuating member 414 for opening valve 410 upon engagement between sub-tank inlet 408 and cartridge outlet 404. For example, when valve 410 is a ball movable along the central axis of cartridge outlet 404, valve actuating member 414 can be provided as a protrusion above the entry port of sub-tank inlet 408, so that upon the engagement between sub-tank inlet 408 and cartridge outlet 404 the protrusion enters cartridge outlet 404 and pushes the ball away from the exit port 412 of cartridge outlet 404, thus opening a flow passage from cartridge 402 into sub-tank 406.

Reference is now made to FIG. 4C which illustrates an enlarged exploded view of a section of sub-tank 406 along a vertical axis thereof, according to some embodiments. Sub-tank 406 also comprises a sub-tank outlet 428, sealingly connectable to the nozzle array by a pipe (not shown, see FIG. 5A), and having an outlet port 430 at the lower part of the internal cavity of sub-tank 406. Preferably, sub-tank 406 is vented to the atmosphere, by means of non-sealed inlet cover 432, or a dedicated vent 434 (see FIG. 5A), so that the pressure above the liquid level in sub-tank 406 is, at all times, the atmospheric pressure. As shown in FIG. 4C, two inlet ports 416 and 418 are provided within sub-tank inlet 408 at different heights relative to a liquid level in sub-tank 406 (when sub-tank 406 contains liquid material) or relative to a base 420 of sub-tank 406. The outlet port 430 is below both inlet ports 416 and 418.

Typically, inlet ports 416 and 418 are provided at the ends of two lumens 422, 424 of different lengths introduced into sub-tank inlet 404. Preferably, the two lumens 422, 424 are embodied as a double lumen conduit 426, as illustrated in FIG. 4C, but embodiments in which the lumens 422 and 424 are separated from each other are also contemplated.

Configuring two inlet ports at different heights in the sub-tank inlet 408 is advantageous since it ensures that cartridge 402 feeds sub-tank 406 with liquid material without the need to employ any electronic control mechanism, as will now be explained. Initially, when sub-tank 406 is empty, and cartridge 402 is mounted on sub-tank inlet 408 such that exit port 412 of cartridge outlet 404 is facing downwards, liquid material enters sub-tank inlet 418 from cartridge outlet 404. At this stage, the material can enter the cavity of sub-tank 406 through either one of, or both, ports 416 and 418. Upon entry of liquid through these ports, air is sucked upwards through ports 416 and 418 into cartridge 402 to replace the vacant volume therein. When the liquid level passes the lower port 418, the material can still enter the cavity of sub-tank 406 through ports 416 and 418, however at this stage air is sucked upwards only through the upper port 416 because port 418 is submerged below the liquid level and so there is no airpath into port 418. When the liquid level reaches the upper port 416, the flow of material into sub-tank 406 is discontinued since there is no airpath into cartridge 402. From this stage onwards, whenever an air gap is formed between the liquid level and the upper port 416, additional liquid immediately enters sub-tank 406, without any intervention by an electronic control.

FIGS. 4D and 4E are schematic illustrations showing an exploded view of sub-tank 406 (FIG. 4D), and a section of sub-tank 406 along its vertical axis, once assembled (FIG. 4E), in embodiments in which a filter assembly 436 is positioned within the cavity of sub-tank 406. Filter assembly 436 serves for filtering the liquid material before it exits sub-tank 406 via port 430 of outlet 428 (not shown in FIGS. 4D and 4E, see FIG. 4C). Filter assembly 436 comprises a filter holder 437 having a base 438 and a top 440, and a filter 439 within filter holder 437. In the configuration shown in FIG. 4D, which is not to be considered as limiting, filter 439 is located on the internal surface of holder 437, so that the material entering sub-tank 406 through sub-tank inlet 408 passes through filter 439 and then exits filter holder 437 from lateral openings formed on holder 437 since base 438 is typically closed. Top 440 is preferably, but not necessarily, an open top. When filter assembly 436 is within the internal cavity of sub-tank 406, the base 438 is below inlet ports 416 and 418, and the top 440 is above inlet ports 416 and 418. In conventional printing systems, a filter is provided on a pipe that provides a sealed connection to the nozzle array of the printing system. The inventors found that such configuration may affect the pressure within the nozzle array. The positioning of filter assembly 436 within the cavity of sub-tank 406 according to some embodiments of the present invention is advantageous since with such a configuration there is no need to position a filter on the pipe that connects to the nozzle array. Since the pressure above the liquid level in sub-tank 406 is the atmospheric pressure, filter assembly 436 does not affect the pressure within the nozzle array.

In some embodiments of the present invention sub-tank 406 comprises a neck 442 below inlet ports 416, 418. At the region of neck 442, the horizontal cross-sectional area of the cavity of sub-tank 406 is smaller than in regions immediately below and immediately above neck 442. The horizontal cross section of sub-tank 406 preferably has an additional narrowing section, for example, in the form of an additional neck 443 generally at the upper portion of sub-tank 406, preferably above inlet port 416. The inventors found that providing sub-tank 406 with necks 442 and 443 is advantageous since it allows extracting various types of information regarding the state of the system, as further detailed in the Examples section that follows.

Reference is now made to FIGS. 5A-C, which are schematic illustrations of a three-dimensional printing system 500 employing material delivery system 400, according to some embodiments of the present invention.

Aside from material delivery system 400, system 500 comprises tray 12, one or more nozzle arrays formed on the orifice plate of printing head 16, and leveling device 32, as further detailed hereinabove. Note that in the illustration of FIG. 5A, leveling device 32 is behind printing head 16. System 500 also comprises computerized controller 20 which is configured to execute at least a portion of the operations described above with respect to systems 10 and 110.

The sub-tank 406 of material delivery system 400 is fed by liquid material 502 from cartridge 402, as further detailed hereinabove, and a sealed fluid communication 504 between sub-tank outlet 428 and head 16 ensures that liquid material 502 is delivered to one or more of the nozzle arrays of head 16 by means of the under-pressure in head 16. Preferably, fluid communication 504 includes a manifold 506 which establishes fluid communication with the nozzle array(s) of head 16 by a first pipe 508 and with sub-tank outlet 428 by a second pipe 510. Manifold 506 can be part of delivery system 400 or of printing system 500. Preferably, but not necessarily, at least first pipe 508 has a flexible wall. Manifold 502 is preferably elevated with respect to the sub-tank 406 and also with respect to head 16.

While FIG. 5A illustrates a case in which printing system 500 employs only one material delivery system 400, this need not necessarily be the case, since typically system 500 comprises a plurality of liquid material delivery systems 400, each delivering liquid material to a different nozzle array of printing head 16. Further, all the nozzle arrays can be of the same printing head or two or more nozzle arrays can be mounted on separate printing heads. However, in any of these embodiments, it is sufficient to have a single manifold 506, with a plurality of manifold inlet ports 510a 510b for connecting to a respective plurality of sub-tank outlets 428, and a plurality of manifold outlet ports 508a, 508b for connecting to a respective plurality of nozzle arrays. In some embodiments of the present invention the outlet ports of manifold 506 are controllable, to allow disconnecting and re-establishing fluid communication between manifold 506 and the nozzle array upon demand. These embodiments are particularly useful for priming the system as explained in greater detail in the Examples section that follows. The control can be manual or by controller 20, as desired.

In some embodiments of the present invention manifold 506 comprises one or more pressure sensing ports 512, each being in fluid communication with a separate sub-tank outlet 428, and system 500 comprises one or more pressure sensors 514 for sensing pressures at pressure sensing port(s) 512.

Computerized controller 20 receives signals from sensor(s) 514 and analyzes these signals to extract one or more parameters indicative of the state of system 500. For example, in some embodiments of the present invention controller 20 calculates an amount of liquid material at each sub-tank, based on a signal received from a respective pressure sensor. In some embodiments of the present invention controller 20 calculates a flow rate of liquid material through each nozzle array, based on a signal received from a respective pressure sensor. In some embodiments of the present invention controller 20 identifies when the respective cartridge is empty. In some embodiments of the present invention controller 20 automatically re-calibrates sensor data corresponding to signals received from a respective pressure sensor, responsively to an identification that the cartridge is empty. In some embodiments of the present invention controller 20 automatically re-calibrates voltage to be applied to a respective nozzle array, responsively to an identification that the cartridge is empty. In some embodiments of the present invention controller 20 analyzes signals received from the respective sensor to identify presence of an air pocket in the pipe 508 that connects to the respective nozzle array. Preferred protocols for extracting such parameters are provided in the Examples section that follows.

In three-dimensional inkjet printing, it is customary to periodically perform a procedure known as purging. The purging procedure is typically executed when changing the building material cartridge that feeds the head, so as to remove the previous building material from the head's channel or other fluid paths in the system. Purging procedure is oftentimes also performed during printing process to ensure that the nozzle arrays of head 16 remain functional and to prevent clogging. Conventionally, the purging procedure includes moving the head to a service station and increasing the pressure inside the head by means of a pump so as to force all the excess building material out through the nozzle array.

The inventors found a technique in which the purging can be executed without increasing the pressure in the head. In some embodiments, system 500 comprises a service station 516 which is controllable by controller 20 and which is configured for engaging the nozzle arrays of head 16 and for applying suction thereto, responsively to a control signal from controller 20. Preferably, the suction is applied by means of a dedicated pump 518, which is disconnected from system 400 and fluid communication 504. For clarity of presentation, piping between pump 518 and service station 516 is not illustrated, but the ordinarily skilled person, provided with the details described herein would know how to connect a suction pipe between pump 518 and service station 516. Thus, in the present embodiments, the purging is accomplished by reducing the pressure outside the head (upon engagement with the suctioning service station), rather than by increasing the pressure inside the head.

In the system illustrated in FIGS. 5A and 5B, tray 12 and service station 516 are mounted on a supporting platform 520 configured to move vertically by means of a vertical driving mechanism 522 actuated by a motor 524. Thus, in these embodiments, both tray 12 and service station move vertically together. Preferably, service station 516 is mounted at a height relative to platform 520 which is less than the height of tray 12. Tray 12 is slidably mounted to platform 520 by means of tracks 526 allowing tray 12 to move along the scanning direction x. Head 16 is slidably connected to a horizontal chassis portion 528 (not shown in FIG. 5A, see FIG. 5B) allowing head 16 to move along the indexing direction y. It is appreciated that tray 12 may alternatively move along the indexing direction y, and head 16 may alternatively move along the scanning direction x.

The suctioning procedure according to some embodiments of the present invention thus includes, moving the head 16 (e.g., along the indexing direction) until it is directly above the service station 516, moving the tray 12 (e.g., along the scanning direction) until the service station is within the field-of-view of the head 16, elevating the platform 520 by means of vertical driving mechanism 522, together with tray 12 and service station 516, until service station 516 engages the nozzle array(s) of head 16, and activating the suction (e.g., by powering pump 518) to extract liquid material out of the nozzle array(s). Since tray 12 is at a higher level than service station 516, the vertical position of tray 12 during the suctioning is above the vertical position of the nozzle array(s) and optionally and preferably also above the vertical position of leveling device 32.

The suctioning procedure of the present embodiments can be used for performing the aforementioned purging procedure, e.g., when changing the building material cartridge that feeds the head and before placing a new cartridge. The suctioning procedure of the present embodiments can also be used for executing a priming protocol at a respective nozzle array, responsively to an identification of the presence of an air pocket in a pipe 508 which connects to the respective nozzle array.

An alternative suctioning procedure, particularly useful for removing the air pocket from pipe 508, can be executed while the nozzle arrays(s) are at a vertical position above manifold 506. Thus, in some embodiments of the present invention system 500 comprises an additional service station 530 configured to receive printing head 16 at a vertical position that is above the position of manifold 506. For example, additional service station 530 can include a platform 532 positioned at a vertical position above manifold 506, for receiving head 16 at that vertical position. Additional service station 530 can also comprise a suction device 534, configured to engage the nozzle array(s) of head 16 once received by platform 532. With reference to FIG. 5C, in use of additional service station 530, printing head 16 is disengaged from the horizontal chassis portion 528 while maintaining the fluid communication of head 16 with manifold 506 by pipe 508. Once disengaged from the chassis, head 16 is placed on platform 532, preferably in a manner that the nozzle array(s) of head 16 are facing upwards. Suction device 534 is then brought to engage the nozzle array(s) of head 16, preferably from above, and is actuated to apply suction to nozzle array(s).

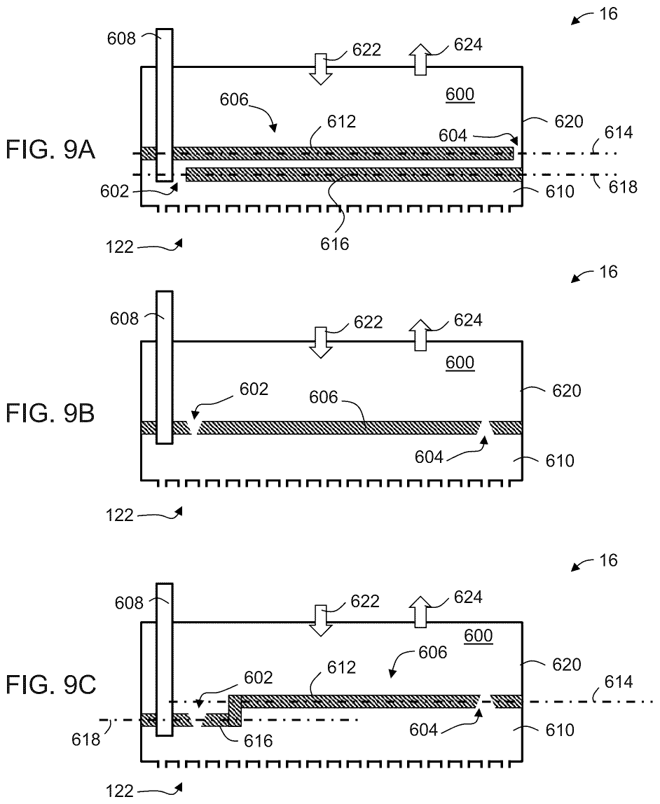

FIGS. 9A-C are schematic illustrations of printing head 16 in embodiments in which the printing head 16 is partitioned vertically. It was found by the Inventors that such a partitioning allows estimating the amount of operative and defective nozzles in the nozzle array in a convenient and simple manner.

Traditionally, operative and defective nozzles have been detected by executing a nozzle test procedure in which the dispensing head dispenses test droplets into a waste container. The container is weighed and the weight is analyzed in order to determine if the nozzle array has defective nozzles based on the difference in the weight of the container before and after the dispensing. The Inventors found that the amount of operative and defective nozzles can be estimated without the need to weigh the waste container, in a manner that will now be explained.

The printing head 16 shown in FIGS. 9A-C comprises a chamber 600 that is vertically partitioned by a partition 606 having an inlet port 602 and an outlet port 604. Chamber 600 is designed to contain liquid material, such as building material in liquid form. In use, chamber 600 is typically in a state of under-pressure to allow it to receive the liquid material from a supply system (e.g., system 400 or 330) via a material delivery port 622 at the upper part 620 of chamber 600. During purging, or after the chamber is emptied, air enters the chamber, and so the pressure increases. The under-pressure can be maintained by means of a pump (not shown) that is in fluid communication with a vacuum port 624 and that is optionally and preferably controlled by the controller of the printing system (e.g., controller 20 of system 10 or 110 or 500).

Head 16 also comprises array 122 of nozzles, in fluid communication with chamber 600, and a pressure sensor 608 that is constituted to measure the pressure at the lower part 610 of chamber 600, below partition 606. In FIGS. 9A-C sensor 608 is illustrated as an elongated rod in which the lower part serves as a pressure sensing element.

Shown in FIGS. 9A-C are three exemplified configurations for partition 606. FIG. 9B illustrates a configuration in which partition 606 is planar, engaging the same plane thereacross. FIGS. 9A and 9C illustrate alternative configurations in which partition 606 has a first surface 612 engaging a first horizontal plane 614 and a second surface 616 engaging a second horizontal plane 618. The inlet port 602 is preferably at the lowest of these two surfaces (surface 616, in this example) and the outlet port 604 is at a highest of these two surfaces (surface 612, in this example). In FIG. 9A, the inlet 602 and outlet 604 are provided in the form of a gap between the respective surface and the side wall of chamber 600. In FIG. 9C, the inlet 602 and outlet 604 are formed in the respective surfaces of partition 606. When partition 606 comprises surfaces 616 and 612 engaging planes 618 and 614, the height difference between surfaces 616 and 612 is preferably from about 5 mm to about 10 mm, e.g., 7 mm.

The inlet 602 serves for allowing the liquid material to enter the lower part 610 of chamber 600 after entering the upper part 620 via delivery port 622. Air in lower part 610 is evacuated upwards through outlet port 604. Since air is lighter than the liquid material, it is advantageous to employ a partition having two surfaces as exemplified in FIGS. 9A and 9C, so that air is more likely to accumulate at the upper surface of the partition and be evacuated through the outlet port. However, the Inventors found that the air can be evacuated also when a planar partition is used as exemplified in FIG. 9B.

Inlet port 602 and outlet port 604 are preferably of approximately the same diameter. A typical diameter for these ports is less than 1 mm, e.g., from about 0.2 mm to about 1 mm, for example, about 0.7 mm. The advantage of having such diameters for ports 602 and 604 is that it amplifies the relation between the pressure in the lower part 610 of chamber 600 and the amount of building material that is dispensed out of the nozzles in array 122. The Inventors found that by a judicious selection of the diameters of ports 602 and 604 the change in the pressure within the lower part 610 is detectable even when just a few nozzles, or even a single nozzle, dispense a single drop of material.

When the viscosity of the liquid in the upper part 620 is too high to allow the liquid to pass through the inlet port 602, a purging operation can be executed as further detailed hereinabove to reduce the pressure at lower part 610 and to facilitate the filling of lower part 610 by the liquid material.

As demonstrated in the Examples section that follows, the inventors found that the pressure below the partition during the dispensing of liquid material through the nozzles in array 122 is indicative of the number of active nozzles in the array (and equivalently also of the number of inactive or defective nozzles, since the total number of nozzles in array 122 is generally known). Thus, according to some embodiments of the present invention the controller of the printing system (e.g., controller 20 of system 10 or 110 or 500) estimates the number of active nozzles in printing head 16 based on a signal received from pressure sensor 608 during dispensing. For example, controller 20 can determine an amount of a pressure drop dP below partition 606 based on the signal from sensor 608, and estimate the number of active nozzles based on the determined amount of pressure drop dP. For example, the controller can access a computer readable medium storing a lookup table in which the entries associate a pressure drop with a number of active or inactive nozzles.

In some embodiments of the present invention the estimation of the number of active nozzles (or equivalently the number of inactive or defective nozzles) is performed during a printing head testing procedure that is executed when the lower part 610 of chamber 600 is filled with liquid material. In these embodiments, the test procedure is preceded by a delivery of liquid material to chamber 600 so as to fill the lower part 610. However, this need not necessarily be the case, since the Inventors found that the number of active nozzles can be estimated without also during a printing process of a three-dimensional object, by monitoring the signal from sensor 608. In this case, it is not necessary to interrupt the printing process of an object for estimating the number of active or defective nozzles.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Protocol for Calculating an Amount of Liquid Material

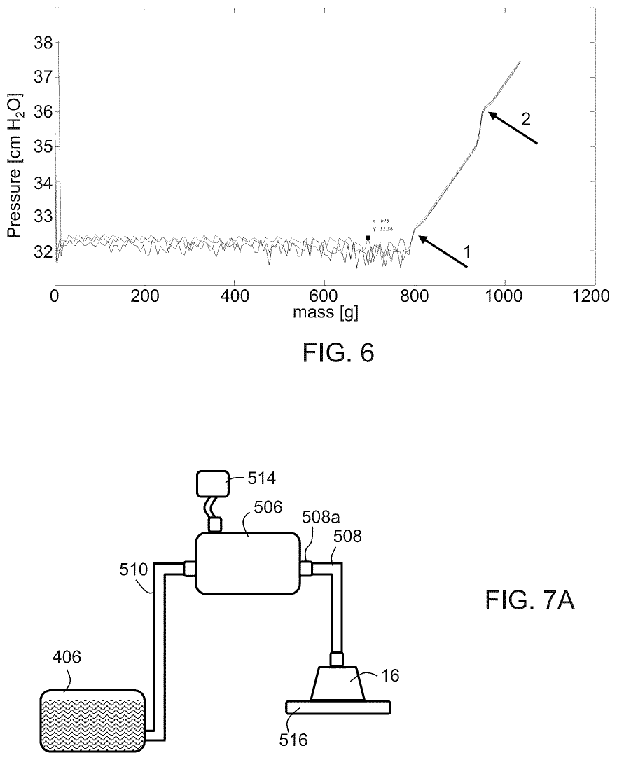

Since the horizontal cross-section of the cavity is smaller at the vertical positions of the necks 442 and 443 of sub-tank 406, time points at which the liquid level passes these vertical positions can be identified by monitoring the pressure measured by sensor 514 over time, and identifying abrupt changes in the monitored pressure. FIG. 6 shows results of experiments performed by the inventors in which the pressure measured by sensor 514 and the amount of liquid that was sucked through sub-tank outlet 428 were monitored over time. Two arrows in FIG. 6 show identified time points at which there are abrupt changes in the monitored pressure. Arrow 1 corresponds to a time point at which the liquid level was at neck 443 and arrow 2 to a time point at which the liquid level was at neck 442.

Given the absolute vertical position Hₙ of the neck 442 and the absolute vertical position Hᵢₙ of neck 443, the difference between the pressure sensor reading Pₙ when the liquid level is at neck 442 and the pressure sensor reading Pᵢₙ when the liquid level is at neck 443, can be used to obtain the liquid level H(P) within sub-tank 406 as a linear function of the pressure sensor reading P at any time, according to the equation:

$$H ( P ) = [ ( {H}_{in} - {H}_{n} ) / ( {P}_{in} - {P}_{n} ) ] ( ( P - {P}_{n} ) + {H}_{n}$$

Preferably, the measurement of P is performed while the nozzle array(s) are inactive.

### Protocol for Calculating Flow Rate

Denoting by ΔP the difference between the pressure reading when nozzle array(s) are dispensing material at a constant flow, and the pressure reading when nozzle array(s) are inactive, one obtains:

$$Δ P = a \times dw / dt$$

where dw/dt is the flow rate to be determined and a is a slope parameter. The slope parameter can be calculated by activating the nozzle array(s) at constant flow between the time points corresponding to arrows 1 and 2 in FIG. 6, and measuring the time difference between these time points. Denoting this measured time difference by T_{1,2}, the slope parameter a can be calculated as:

$$a = ( {P}_{in} - {P}_{n} ) / [ W / T ]$$

where W is the volume of liquid between necks 442 and 443. Once the slope parameter is calculated, the flow rate can be determined as a function of the aforementioned pressure difference ΔP, according to the equation:

$$dw / dt = Δ P / a$$

The flow rate per nozzle can be calculated as (dw/dt)/N, where N is the number of nozzles in the array.

### Protocol for Re-Calibrating Nozzle Array Voltage

To re-calibrate nozzle array voltage, the nozzle array is operated at different voltages, and the flow rate dw/dt is measured for each voltage. This provides a look-up table of the flow rate as a function of the voltage applied to the nozzle array. The voltage to be used for fabricating a three-dimensional object can then be selected based on the desired flow rate.

Preferably, the cartridge 402 is removed from sub-tank 406 before executing this protocol, so as to reduce the amount of noise.

### Protocol for Detecting Defective Nozzles by Monitoring Flow Rate

To detect defective nozzles, the flow rate dw/dt is monitored periodically. Deviation of the flow rate from the value as dictated by the aforementioned re-calibration protocol, is indicative of an existence of one or more defective nozzles in the nozzle array. To identify the defective nozzles within the array, the nozzles of the array are operated in series, and the flow rate per nozzle is monitored. A nozzle for which the flow rate per nozzle deviates from the value as dictated by the aforementioned re-calibration protocol can be defined as defective.

### Protocol for Identifying Air Pocket in Pipe 508

An air pocket in pipe 508 can be identified wherever operation of the nozzle array does not result in any change in the pressure reading of sensor 514.

### Priming Protocol

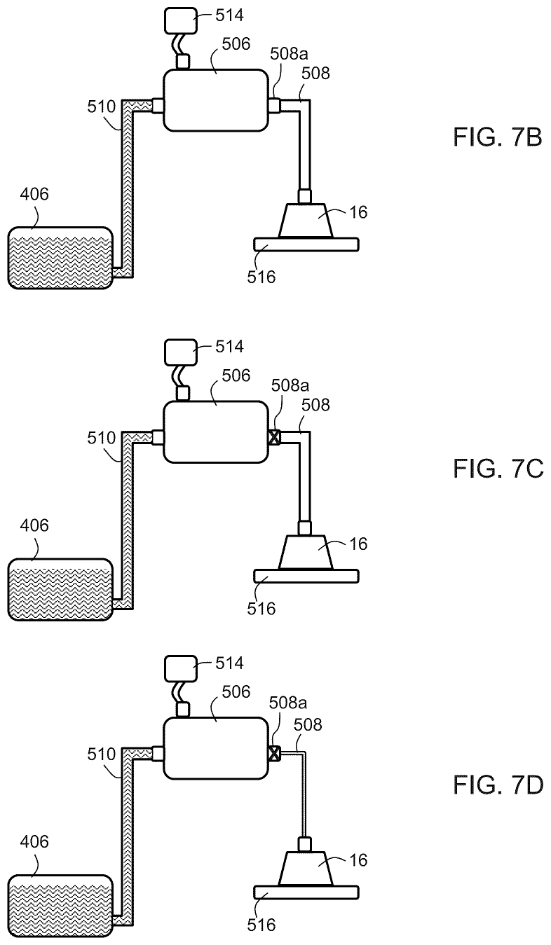

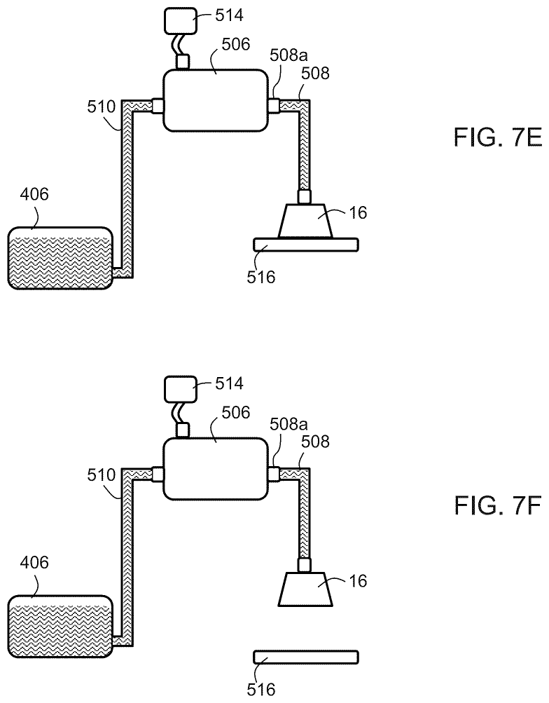

A priming protocol is preferably executed when an air pocket in pipe 508 is identified. The priming protocol is preferably executed automatically, but can in some embodiments of the present invention be executed manually. The priming protocol is described with reference to FIGS. 7A-F. The protocol begins by engaging the service station 516 with the nozzle array(s) of head 16 (FIG. 7A). The protocol continues by applying suction to the nozzle array(s), while monitoring the pressure with sensor 514. This operation continues until there are no changes in the pressure reading. After this operation, pipe 510 is filled with liquid (FIG. 7B). The protocol continues by controlling the manifold outlet 508a connected to pipe 508 to block flow through manifold outlet 508a (FIG. 7C). The protocol continues by continuing the suction to the nozzle array(s). This operation continues until pipe 508 collapses (FIG. 7D). The protocol continues by controlling the manifold outlet 508a connected to pipe 508 to allow flow through manifold outlet 508a, and then continues by continuing the suction to the nozzle array(s). This operation continues until pipe 508 is filled with liquid (FIG. 7E). The protocol continues by disengaging service station 516 with the nozzle array(s) from head 16 (FIG. 7F).

### Head Replacement Protocols

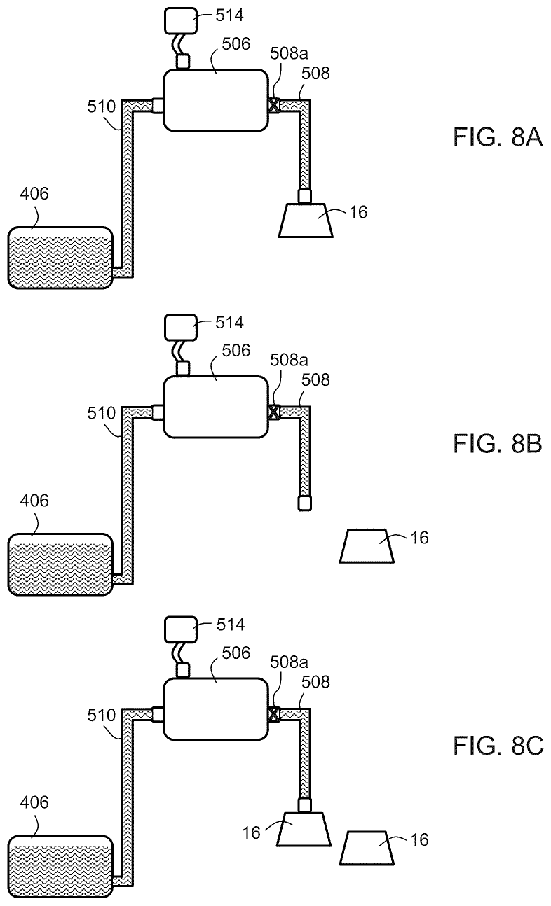

A first head replacement protocol is described with reference to FIGS. 8A-8C. The protocol begins by controlling the manifold outlet 508a connected to pipe 508 to block flow through manifold outlet 508a. At this stage, both pipes 510 and 508 are filled with liquid (FIG. 8A). The protocol continues by removing the printing head from the system (FIG. 8B), and then mounting a replacement printing head (FIG. 8C).

In a second head replacement protocol, the head is disengaged from the chassis portion while maintaining the fluid communication of head 16 with manifold 506 by pipe 508. Once disengaged from the chassis, head 16 is placed on platform 532. The head is replaced while on platform 532 and the replacement head is mounted on the chassis. In a case in which there is an air pocket in pipe 508, suction is applied to the nozzle array(s) of the replacement head (see FIG. 5C) before the replacement head is mounted on the chassis. Once the replacement head is mounted on the chassis, suction is terminated.

### Protocol for Detecting Defective Nozzles by Monitoring Pressure in the Head

With reference to FIGS. 9A-C, when the nozzles in the array 122 dispense the liquid material, the amount of liquid material in the lower part 610 of chamber 600 is reduced and the liquid in the upper part 620 flows downwards through the inlet port 602. At the same time, air is evacuated upwards through outlet port 604. The contributions to the pressure in the lower part 610 include a contribution due to the viscosity of the liquid, a contribution due to the density of the liquid, and a contribution due to the surface tension of the liquid. A change in the rate at which the liquid flows into the lower part 610 of chamber 600 therefore affects the pressure in lower part 610.

Experiments were performed using the printing head shown in FIG. 9C, a liquid material having a viscosity of about 6.5 cps, was dispensed at a dispensing rate of about 15 cc/min (192 nozzles). The signal from pressure sensor 608 was monitored during the dispensing and during the filling of lower part 610 between dispensing batches, where in each batch a different number of nozzles was activated. The sampling rate was 3.17 Hz, corresponding to a period of about 315 ms per sample.

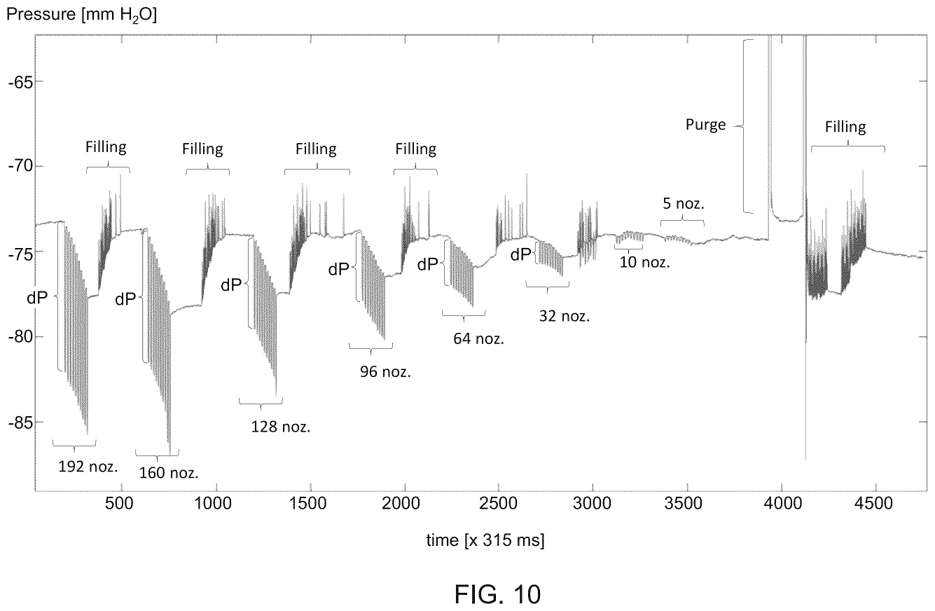

FIG. 10 is a graph of the pressure measured by sensor 608 in mmH₂O as a function of the time. The number of active nozzles for each batch is indicted on the graph (“noz.” abbreviates “nozzles”). As shown, the amount of pressure drop dP as measured by the pressure sensor within the lower part of the chamber, below the partition, is indicative of the number of active nozzles. Specifically, the absolute value of dP decreases as a function of the number of active nozzles.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A system for delivering liquid material to a nozzle array of a printing system, the system comprising:
a cartridge having a cartridge outlet and containing the liquid material; and
a vented sub-tank having a sub-tank inlet configured to receive said cartridge outlet to allow the liquid material to flow through said cartridge outlet by gravity, two inlet ports within said sub-tank inlet at different heights relative to a liquid level in said sub-tank, and a sub-tank outlet sealingly connectable to the nozzle array by a pipe and having an outlet port below said inlet ports.

2. The system according to claim 1, wherein said sub-tank comprises a filter having a base below said inlet ports and a top above said inlet ports.

3. The system according to claim 1, wherein said cartridge outlet comprises a valve.

4. The system according to claim 3, wherein said sub-tank inlet comprises a valve actuating member for opening said valve upon engagement between said sub-tank inlet and said cartridge outlet.

5. The system according to claim 1, wherein said sub-tank comprises a neck below said inlet ports.

6. The system according to claim 1, comprising a manifold wherein said sub-tank outlet is sealingly connectable to the nozzle array via said manifold.

7. The system according to claim 6, wherein said manifold is elevated relative to said sub-tank outlet.

8. A system for three-dimensional printing, comprising:
a plurality of liquid material delivery systems, each comprising the system according to claim 6, wherein said delivery systems share said manifold, and wherein a sub-tank outlet of each delivery system is connected to a separate manifold inlet;
a plurality of nozzle arrays each connected to a separate manifold outlet and being configured for dispensing the liquid material received via said manifold;
a computerized controller having a circuit configured for operating said nozzle arrays to sequentially dispense a plurality of layers in a configured pattern corresponding to a shape of a three-dimensional object.

9. The system according to claim 8, wherein said manifold is elevated relative to said sub-tank outlet.

10. The system according to claim 9, wherein said manifold comprises a plurality of pressure sensing ports, each being in fluid communication with a separate sub-tank outlet, and the system comprises a plurality of pressure sensors for sensing pressures at said pressure sensing ports.

11. The system according to claim 10, wherein said computerized controller is configured for receiving signals from said sensors, and for calculating an amount of liquid material at each sub-tank, based on a signal received from a respective pressure sensor.

12. The system according to claim 10, wherein said computerized controller is configured for receiving signals from said sensors, and for calculating a flow rate of liquid material through each nozzle array, based on a signal received from a respective pressure sensor.

13-17. (canceled)

18. The system according to claim 8, comprising a service station controllable by said computerized controller and being configured for engaging said nozzle arrays and applying suction thereto responsively to a control signal from said computerized controller.

19-21. (canceled)

22. A system for three-dimensional printing, comprising:
a plurality of nozzle arrays each being configured for dispensing liquid material;
a computerized controller having a circuit configured for operating said nozzle arrays to sequentially dispense a plurality of layers in a configured pattern corresponding to a shape of a three-dimensional object; and
a service station controllable by said computerized controller and being configured for engaging said nozzle arrays and applying suction thereto responsively to a control signal from said computerized controller.

23. The system according to claim 22, comprising a tray, wherein said plurality of layers are dispensed on said tray, and wherein said computerized controller is configured for controlling a vertical position of said tray.

24. The system according to claim 23, wherein said computerized controller is configured for controlling a vertical position of said service station to engage said nozzle arrays, and wherein said tray moves along a vertical direction together with said service station.

25. The system according to claim 24, comprising a leveling device for leveling said dispensed layers, and wherein during said engagement, a vertical position of said tray is above a vertical position of said leveling device.

26. A method of priming, comprising:
providing a system for three-dimensional printing having a liquid material delivery system which comprises the system according to claim 1, a manifold which is formed with a sensing port and which is sealingly connected to the nozzle array by a first pipe and to said sub-tank by a second pipe, and a pressure sensor for sensing pressures at said pressure sensing port;
analyzing signals generated by said pressure sensor to identify an air pocket in said first pipe; and
removing said air pocket, responsively to said identification, thereby priming the system.

27-29. (canceled)

30. A printing head for three-dimensional printing, comprising:
a chamber, vertically partitioned by a partition having an inlet port and an outlet port;
an array of nozzles in fluid communication with said chamber; and
a pressure sensor constituted to measure pressure below said partition.

31-34. (canceled)

35. A system for three-dimensional printing, comprising:
the printing head according to claim 30; and
a computerized controller having a circuit configured for operating the printing head to sequentially dispense a plurality of layers in a configured pattern corresponding to a shape of a three-dimensional object, and for estimating a number of active nozzles in the printing head based on a signal received from said pressure sensor during said dispensing.

36-37. (canceled)
